(19) United States
(12) Patent Application Publication
(10) Pub. No.: US 2004/0104127 A1
(43) Pub. Date: Jun. 3, 2004

(54) Process and composition for obtaining an aqueous chlorine dioxide ready for its use, stabilized in a carbonate buffer, being a powerful disinfecting agent with ecological, non residual non toxic and non phytotoxic cataloging in the concentrations of usage

(76) Inventor: Juan Luis Araya Rojas, Santiago (CL)

Correspondence Address: GREENBERG TRAURIG LLP, 2450 COLORADO AVENUE, SUITE 400E, SANTA MONICA, CA, 90404, US

(21) Appl. No.: 10/447,572

(22) Filed: May 22, 2003

(30) Foreign Application Priority Data
Dec. 2, 2002 (CL) 2762-2002

(51) Int. Cl. C01B 11/02; C25B 1/24

(52) U.S. Cl. 205/556; 423/477

(57) ABSTRACT

The process and composition for to obtain chlorine dioxide in aqueous solution, ready to use, stabilized in buffer carbonate, being a powerful disinfectant agent, environmental classification, non residual, non toxic and non phytotoxic at use concentrations, characterized because the process understands an analysis of raw materials mainly the chloride metallic, main component for the reaction; it gets ready brines solution, the brine is a solution of sodium chloride at 20° C.-25° C. with soft water, the brine concentrations is at 9 to 15% parts in weight; then the brines are made go by an electrochemical cell, this cell are forming with silicoses iron, the composition is unknown, but is the same panels used in light conversion (DC/AC transformation) panels; the difference of potential is caused in voltaic cells at laminar regime, so that it produces the oxidation of the metallic chloride and to obtain in direct form the active principle of the invention, chlorine dioxide.

### RELATED APPLICATIONS

Not Applicable

### FIELD OF THE INVENTION

Not Applicable

### BACKGROUND OF THE INVENTION

The present invention is referring to a process and composition for obtain chlorine dioxide aqueous solution stabilized in a carbonate buffer, ready to use, being a powerful disinfectant agent, environmental classification, non residual, non toxic and non phytotoxic when utilized in applicable concentrations.

It is also a powerful viricide, bactericide, fungicide, acaricide and insecticide. The prove of presence of chlorine dioxide is by the methodology recommended by EPA (Environmental Protection Agency) to the APHA (American Public Health Association) 4500 ClO₂ D and 4500 ClO₂ E that it allows to identify all the chlorinated species in a solution, chlorine dioxide is only presented in the product of invention. This had allowed that the product of the invention is applied in very low concentrations, not more 1000 Mg/litter.

Actually exist three sources in the chlorine dioxide production:

The generation in situ starting from sodium per chlorate, used in paper industry like as bleach.

Dry chlorine dioxide wet gas is obtaining by generating machines, the best in a market is Bello Zon® chlordioxid by Prominent (http://www.prominent.de/en/), the raw materials used is a mixture of sodium chlorate and hydrochloric acid, generally used in water disinfections.

Sodium chlorite solutions that generate chlorine dioxide insitu using phosphoric acid as activator. For example, a chemical such as Purogene by Bio Cide Co., reactions may be useful for these three points.

Na ClO₃/acidic medium, with methanol like as stabilizer produce ClO₂ Eka Nobel patent NZ231088

NaClO₂+HCl—→ClO₂

NaClO₂+H₃PO₄—→ClO₂

In attention to the previous art, the patent U.S. Pat. No. 5,380,517 (EKA NOBEL AB) it refers to a process for continuously producing chlorine dioxide by reacting an alkali metal chlorate, sulfuric acid or another chlorine free mineral acid and hydrogen peroxide as reducing agent to produce chlorine dioxide in an aqueous reaction medium. In the process chlorine dioxide is generated in at least one reaction step comprising at least one reaction vessel, by feeding alkali metal chlorate, acid, hydrogen peroxide and inert gas to said reaction vessel, in substantial absence of added chloride ions. The aqueous reaction medium in said reaction vessel is maintained at a pressure of from about 400 mm Hg to about 900 mm Hg and at a temperature of from about 35.degree. C. to about 100.degree. C. and at an acidity within a range from about 4 to about 14 N and the chlorate concentration of between about 0.05 moles/1 to saturation. Chlorine dioxide, oxygen and inert gas and the depleted aqueous reaction medium is withdrawn from said reaction zone without substantial crystallization of alkali metal sulfate.

### SUMMARY OF THE INVENTION

The process and composition for to obtain chlorine dioxide in aqueous solution, ready to use, stabilized in buffer carbonate, being a powerful disinfectant agent, environmental classification, non residual, non toxic and non phytotoxic at use concentrations, characterized because the process understands an analysis of raw materials mainly the chloride metallic, main component for the reaction; it gets ready brines solution, the brine is a solution of sodium chloride at 20° C.-25° C. with soft water, the brine concentrations is at 9 to 15% parts in weight; then the brines are made go by an electrochemical cell, this cell are forming with silicoses iron, the composition is unknown, but is the same panels used in light conversion (DC/AC transformation) panels; the difference of potential is caused in voltaic cells at laminar regime, so that it produces the oxidation of the metallic chloride and to obtain in direct form the active principle of the invention, chlorine dioxide.

a) Na Cl_{(aqueous)}+voltaic cell—→ClO_{2 (aqueous)}

b) a solution+Air (carbon dioxide+oxygen)

c) analysis

d) go to a), 10-15 steps until desired concentration.

According to their characteristics of the invention, aqueous solution of chlorine dioxide, it can be applied in a great uses spectrum, such as:

[symbol] The fish preservation in pelagic catcher.

[symbol] Fish meals production of high quality with a low content of biogenic amines and free of pathogenic micro organisms such as: E. Coli spp, Salmonella spp, Clostridum spp, etc.

It can be used as preventive agent in the insurance quality system like as HACCP (Hazardous appointment control critical point) in food industry.

It can be also applied as disinfectant agent in drinking water in substitution of the chlorine, since this last one in presence of the organic matter reacts to form trihalometans (THMs) that today they were proven carcinogenic agent for human. The invention doesn't react with the organic matter and it is an effective water disinfectant agent and in some occasions they react with heavy metals, such as vanadium and manganese (toxic in the water) they precipitated and for to be retired by filtration of the drinking water.

### DETAILED DESCRIPTION OF THE INVENTION

For to understand better the characteristics of the process and composition of the present invention, we will describe it according to the realization method and to their composition:

The steps to get at the invention are following described:

1.—The first step is the raw materials analysis, mainly the metallic chloride, because is a principal component in the reaction.

a) Concentrations

b) Humidity.

c) Insoluble contents

d) Metals like iron, calcium, magnesium, chromium vanadium and manganese, silica and sulphite.

2.—The brine preparation is at 25° C. with soft water at concentration of 9 to 15% weight parts, this solution is analysed as following:

a) Chloride concentrations Analysis.

b) Density.

c) Insoluble Content.

d) Metals like iron, calcium, magnesium, chromium vanadium and manganese, silica and sulphite.

3.—When the brine solutions is ready for reaction, it is in put in a electrochemical cell of silicosis iron panel.

4.—In such a way that the difference of potential caused by a voltaic cell in a laminar regimen produces the oxidation of the metallic chloride in the water solution and to obtain directly the present of active principle the this invention, chlorine dioxide.

5.—In the anode the difference of potential promote the water hydrolysis and alkaline metal hydroxide is generated.

6.—In anode is constantly flow addition of carbonic anhydride and liquid oxygen in order to eliminate of hydrogen formation and that the hydroxide of alkaline metal is converted in carbonated salt.

7.—The end point of the electrochemical cell, it is obtained a mixture of aqueous chlorine dioxide chlorine gradually among 5 to 7% weigh parts, and sodium carbonate, among 3 to 5% weighs parts, bicarbonate of sodium among 3 to 5% weight parts and sodium chloride among 3 to 7% weight. Parts

a) Na Cl_{(aqueous)}+voltaic cell—→ClO_{2(aqueous)}

b) a solution+Air (carbon dioxide+oxygen)

c) analysis

d) go to a), 10-15 steps until desired concentration

8.—The concentration of the invention and their by-products are controlled by voltaic cell in cell, the step is a brine addition in order to achieve the required concentration at the end of the line.

9.—The general process consists of 14 on-line voltaic cells.

10.—Being obtained at the end a slightly yellowish clear product to a temperature of 10-12° C.

The invention has a great particularity, the chlorine dioxide and by-products, they are manufactured thermodynamically stable for this way stable 99% of chlorine dioxide of chlorine is crystallized in the water cluster adopting the same symmetry space that the carbonate of the alkaline metal and that of the water, by this way the gas (dioxide of chlorine) aqueous solution is like as a reticulation of this gas in the water, this allows its great stabilization and its quick action like disinfectant at low concentrations

The chlorine dioxide precursors and generators, (was describe in paragraph 0005) like they are generating insitu, the molecule formed is a kinetically stable, which is highly volatile and of the great difficult in maintaining a stable solution prepared, one also runs the explosion risk for accumulation of dry gas in closed room preparation.

Those skilled in the art will understand that the preceding exemplary embodiments of the present invention provide the foundation for numerous alternatives and modifications thereto. These other modifications are also within the scope of the present invention. Accordingly, the present invention is not limited to the embodiments precisely shown and described above.

What is claimed is:

1. A process and composition to obtain a aqueous chlorine dioxide solution, ready to use, stabilized in buffer carbonate, being a powerful disinfectant agent, environmental classification, non residual, non toxic and non phytotoxic at use concentrations, wherein the process understands the following steps:
The first step is raw materials analysis, mainly the metallic chloride, because is a principal component in the reaction.
The brine preparation is at 20° C.-25° C. with soft water at final concentration of 9 to 15% weight parts, this solution is analysed.
After being under conditions the brine solution for the reaction, it is made go by an electrochemical cell with silicose iron panels (anodes and cathodes).
A difference of potential is caused in voltaic cell at laminar regime, so that it produces the oxidation of the metallic chloride and to obtain in direct form the active principle of the invention, chlorine dioxide.
In the anode the difference of potential promote water hydrolysis, and alkaline hydroxide is generated.
The anode the addition of constantly flows of carbon dioxide and liquid oxygen in order to eliminate the hydrogen formation and that the hydroxide alkaline metal is converted in carbonated salt.
At the end point of the electrochemical cell, it is obtained a mixture of aqueous chlorine dioxide gradually among 5 to 7% weigh parts, sodium carbonate, among 3 to 5% weighs parts and sodium bicarbonate among 3 to 5% weight parts and sodium chloride among 3 to 7% weight parts.
The concentration of the invention and their by-products, they are controlled by voltaic cell the step is a brine addition in order to achieve the required concentration at the end of the line.
Being obtained at the end a slightly yellowish clear product to a temperature of 10-12° C.

2. A process and composition to obtain chlorine dioxide in aqueous solution, according to the claimed number 1, wherein the analysis of the components understands:
a) Concentration.
b) Humidity.
c) Insoluble content,
d) Metals like iron, calcium, magnesium, chromium vanadium and manganese, silica and sulphite.

3. A process and composition to obtain chlorine dioxide aqueous, according to the claimed number 1, wherein the anode is constantly of carbonic anhydride and liquid oxygen, in order to eliminate of hydrogen formation and that the hydroxide of alkaline metal is converted in carbonated salt.

4. A process and composition to obtain chlorine dioxide aqueous solution, according to the claimed number 1, wherein in reaction the chlorine dioxide and their by-products, they are manufactured thermodynamically stable for this way 99% of chlorine dioxide is crystallized in the water cluster adopting the same symmetry space that the carbonate of the alkaline metal and that of the water, by this way the gas (chlorine dioxide) aqueous solution it is a reticulation of this gas in the water, this allows its great stabilization and its quick action like disinfectant to low concentrations.

5. A process and composition to obtain chlorine dioxide aqueous solution, according to the claimed number 1, wherein for the obtaining of the stable solution of chlorine dioxide, the process in general consists of 14 on-line voltaic cells.
